(19) United States
(12) Patent Application Publication
(10) Pub. No.: US 2013/0042775 A1
(43) Pub. Date: Feb. 21, 2013

(54) BONDED MICROPOROUS SYNTHETIC RUBBER FOR FLASH PREINK STAMPS

(71) Applicant: Hemal Narendra, Mangalore (IN)

(72) Inventor: Hemal Narendra, Mangalore (IN)

(21) Appl. No.: 13/566,094

(22) Filed: Aug. 3, 2012

(30) Foreign Application Priority Data
Aug. 19, 2011 (IN) 2842/CHE/2011

(51) Int. Cl. B41K 1/38; B32B 3/10; B32B 37/14; C08L 23/12; C08F 110/06

(52) U.S. Cl. 101/335; 521/134; 521/143; 156/60; 428/195.1

(57) ABSTRACT

A bonded microporous synthetic rubber, used in the manufacturing of pre-inked stamps and more specifically in the manufacturing of flash preink stamps, is disclosed. The bonded microporous synthetic rubber is made by gluing synthetic rubber with a polypropylene foam using synthetic glue. A tracing sheet containing the image of the desired text of the stamp is placed on the microporous synthetic rubber and it is exposed in a flash stamp system (with Xenon tubes) which delivers an intense burst of light that seals the non- printing area, thereby producing an image of precise resolution. After producing the image, the bonded microporous synthetic rubber is glued to a refillable stamp mount/pocket stamp mount. The refillable stamp mount includes an inking tube through which flash ink is poured. The bonded microporous synthetic rubber has good ink absorption and retention and thus in turn supports a greater number of impressions per inking.

### FIELD OF THE INVENTION

The present invention relates to a bonded microporous synthetic rubber used in the manufacturing of self-inked stamps and more specifically in the manufacturing of flash preink stamps.

### BACKGROUND OF THE INVENTION

Most conventional stamps contain a stamping member which is mounted on a handle that is grasped by the user. The stamping member is placed on the inkpad, which contains the ink. The inked stamping member is then pressed against the corresponding surface to transform the desired image. Each time, the stamping member has to be pressed against the inkpad to transfer the image. This creates discomfort to the user and it is also a time consuming process for numerous stampings. Moreover, separate inkpads that are periodically re-inked are also required.

Problems associated with conventional stamps have led to the development of self-inked stamps that can overcome the above mentioned disadvantages. Generally self-inked stamps contain an inkpad housing wherein an inkpad is disposed in the inkpad housing. The inkpad is one or more of a cloth pad, a foam pad associated with an ink reservoir. Stamping is performed by a downward compression facilitated with a spring arrangement. In these kinds of stamp assemblies, a lighter imprint may result if the stamp indicia is not compressed sufficiently, while an overly dark or smudged imprint may result if the indicia is compressed too much.

Though pre-inked stamps overcome the disadvantages of conventional stamps, the stamping process becomes effective only if the stamp assembly is capable of delivering perfect impressions. The marking surface of the pre-inked stamp is made up of varied materials with varying fluid retention capabilities. The ink absorption and retention of the material should be high and there should not be any leakage of ink through the material during usage. Two of the most important properties for a well-functioning pre-inked stamps are even printing and proper ink flow to the surface area.

U.S. Pat. No. 4,927,695 to Ooms et at teaches an improved microporous marking structure having a layer of a microporous material containing a marking fluid and an absorbent backing layer (Le) polypropylene felt superposed thereon. The marking structure according to the invention may be advantageously used to make a self-inking hand stamp. Here the backing layer requires treatment with a sizing material. Moreover, the marking structure is formed by a complex process of placing a premix capable of forming a microporous structure containing a marking fluid in a mold, placing an absorbent backing layer on the premix, heating the premix to form a microporous structure therefrom, and cooling the microporous structure.

PCT publication WO/2001/058689 to Malczynski et al discloses a preinked stamp with ink reservoir. It includes a die plate made up of a microporous flexible material that can be made of polyethylene, polyolephine or polyurethane. The microporous die material is sealed with ink reservoir body by heat, glue or microwaves. Here, carbon liquid is used as heat absorbent in stamp exposure process. The stamp is developed by covering the microporous die material with carbon liquid until it gets completely black. The process becomes time consuming as the constituents of the carbon liquid (i.e) ethanol should evaporate from the liquid and other liquid components should stick to the stamp die material.

PCT publication WO/2001/068374 to Malczynski et at teaches a two layered microporous stamp material for a pre-inked stamp. Here, two different microporous materials which include a) die plate microporous material developed for printing surface and b) cartridge microporous material plate for ink absorption are used. Both are assembled using heat or assembled in the frame which acts as a holder. The ink cartridge is a preinked cartridge and it does not include a separate ink reservoir.

There are numerous pre-inked stamps which use a microporous synthetic material as an ink retaining material and to disperse the ink contained therein to the surface. However, bonded microporous synthetic rubber according to the present invention for use in the manufacturing of pre-inked stamps is unknown. So, clearly there is a need for a bonded microporous synthetic rubber with better ink absorption and retention.

The present invention fulfils the above mentioned drawbacks of the prior art by providing a bonded microporous synthetic rubber used in the manufacturing of pre-inked stamps that deliver non spreading and sharp impressions.

### SUMMARY OF THE INVENTION

The present invention provides a novel bonded microporous synthetic rubber, used in the manufacturing of pre-inked stamps. The bonded microporous synthetic rubber is developed by the bonding of synthetic rubber which is microporous in nature to a polypropylene foam.

The present invention provides a process for making bonded microporous synthetic rubber comprising a synthetic rubber which is microporous in nature and a polypropylene foam. Both these materials are glued to each other using a synthetic glue, The synthetic glue is applied to the border of both the materials and glue dots/straight lines/round shape of glue are applied in the centre to ensure right bonding. The process of applying the synthetic glue is done by an automated fluid dispensing equipment.

Further, the process includes placing a tracing sheet containing the image of the desired text of the stamp on the microporous synthetic rubber and it is exposed in a flash stamp system (with Xenon tubes) which delivers intense burst of light that seals the non-printing area, and produces an image of precise resolution. Once the image has been created, the bonded microporous synthetic rubber is glued to a refillable stamp mount/pocket stamp mount. The refillable stamp mount includes an inking tube through which the flash ink can be poured.

There are many advantages achieved by the bonded microporous synthetic rubber of the present invention for pre-inked stamps when compared to microporous materials in conventional stamp pad. The absorption and retention of ink in the microporous synthetic rubber is more and fast, which support in delivering more number of impressions per inking.

The process becomes easy using the bonded microporous synthetic rubber as the whole process of dipping the product for ink absorption is eradicated.

Further, the present invention includes the advantage of avoiding over inking as fixed quantity of inks is poured through the inking tube. Thus, the flash preink stamp using microporous synthetic rubber delivers non spreading impressions.

Other features and advantages of various aspects of the invention will become apparent with reference to the following detailed description.

### BRIEF DESCRIPTION OF THE DRAWINGS

FIG. 1(a) is an image of synthetic rubber;

FIG. 1(b) is an image of polypropylene foam material;

FIG. 2 shows an automated fluid dispensing equipment;

FIG. 39a) shows a flash stamp exposure system;

FIG. 3(b) also shows the flash stamp exposure system;

FIG. 4 illustrates the glue application to the refillable plastic mount;

FIG. 5 illustrates the glue application on the sides of the microporous synthetic rubber;

FIG. 6 shows the sealed microporous synthetic rubber placed on the refillable stamp mount; and

FIG. 7 shows illustrates the process of flash preink ink filling.

### DETAILED DESCRIPTION OF THE INVENTION

The present invention provides an improved bonded synthetic rubber, used in the manufacturing of self-inked stamps and more specifically in the manufacturing of flash preink stamps. The bonded microporous synthetic rubber has the advantage of good ink absorption and retention that helps in delivering more number of impressions per inking.

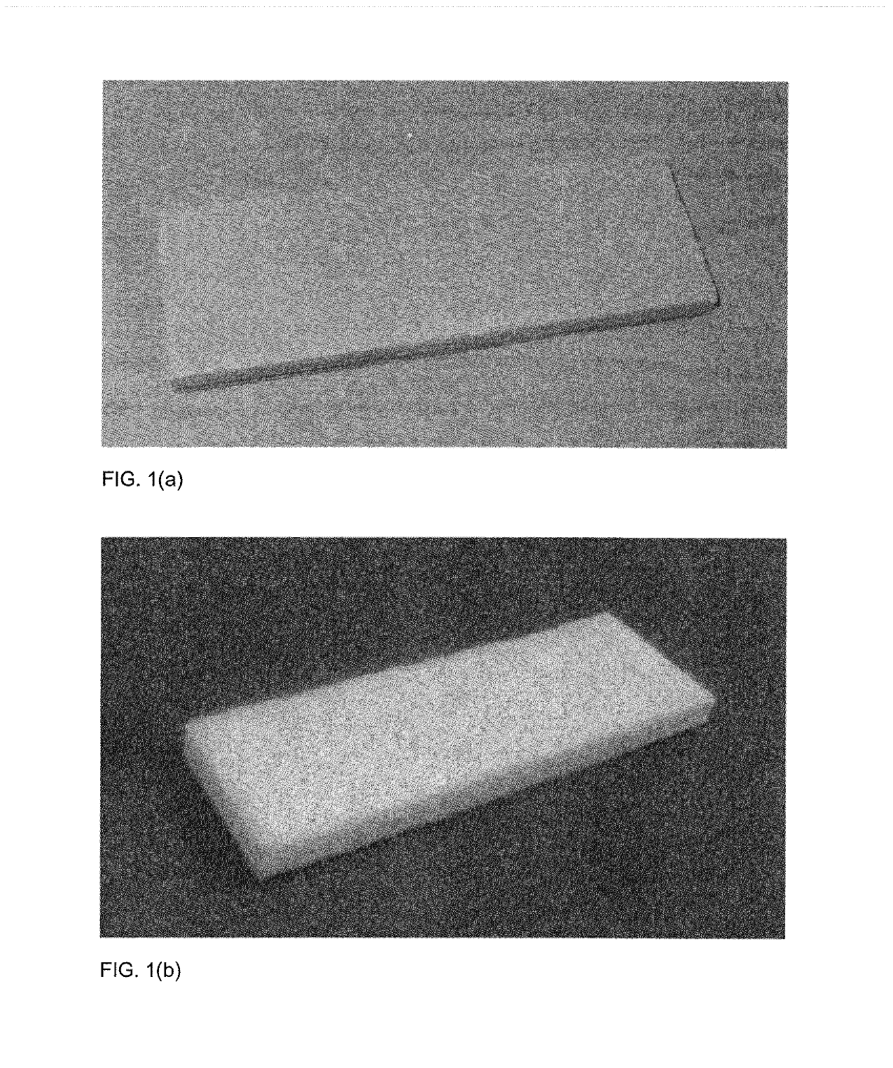

Referring now to the invention in more detail, in FIG. 1(a) a synthetic rubber which is microporous in nature is shown and in FIG. 1(b) a polypropylene foam is shown. The synthetic rubber FIG. 1(a) has a porous structure which can retain ink and gradually deliver small amount of ink when pressed. The polypropylene foam FIG. 1(b) is a stamp pad material which absorbs ink quickly and has a property of further transferring the ink.

According to the present invention, the synthetic rubber FIG. 1(a) and the polypropylene foam material FIG. 1(b) are glued to each other using a synthetic glue to form the bonded microporous synthetic rubber. The synthetic glue is applied to the synthetic rubber and the polypropylene foam. The synthetic glue is applied to the border of both the materials and glue dots/straight lines/round shape of glue are applied in the centre to ensure right bonding.

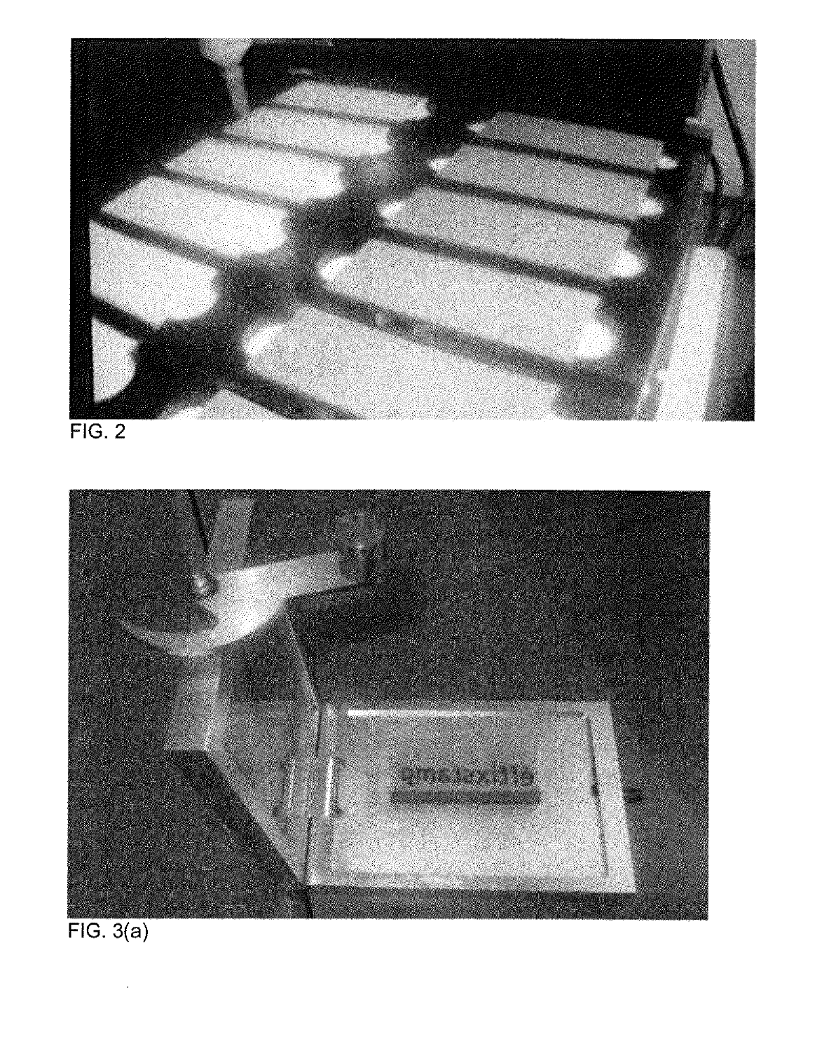

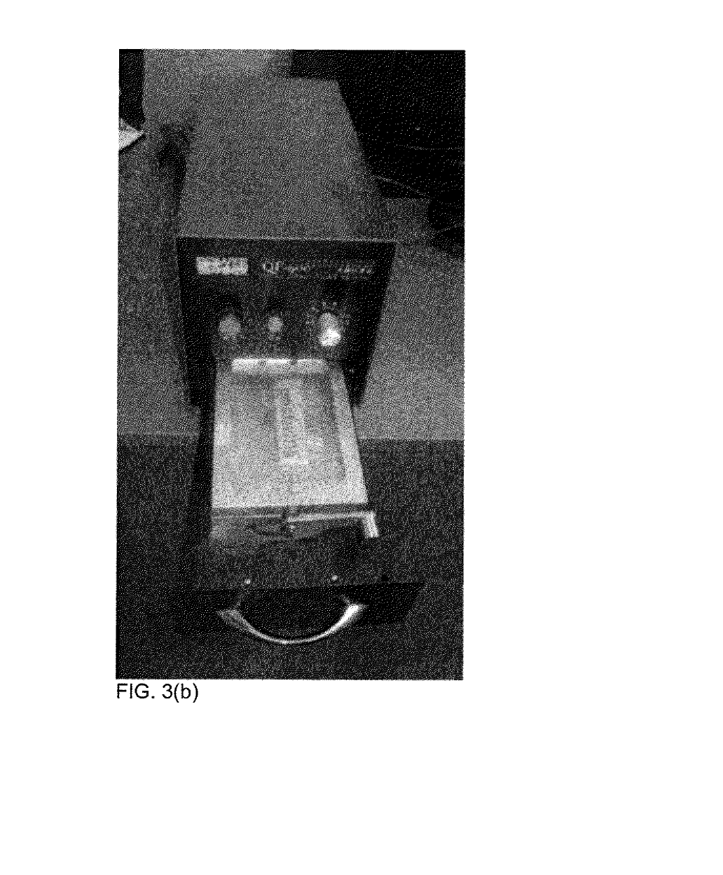

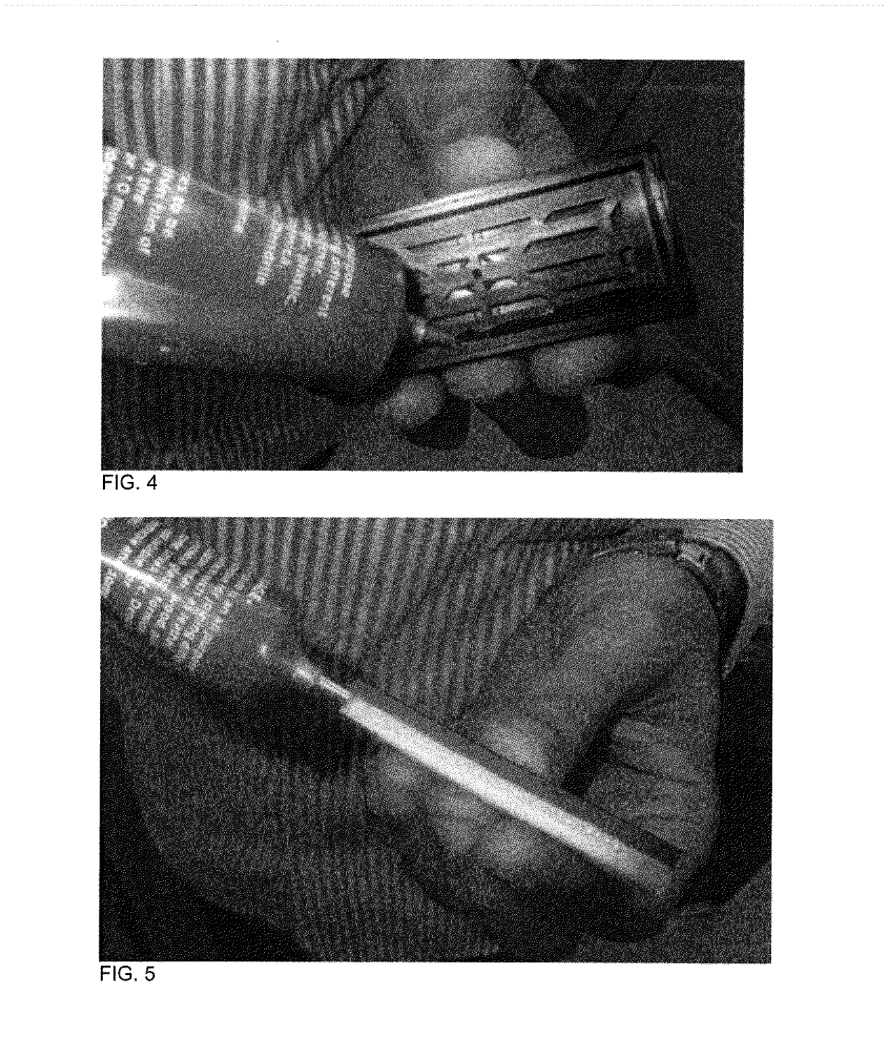

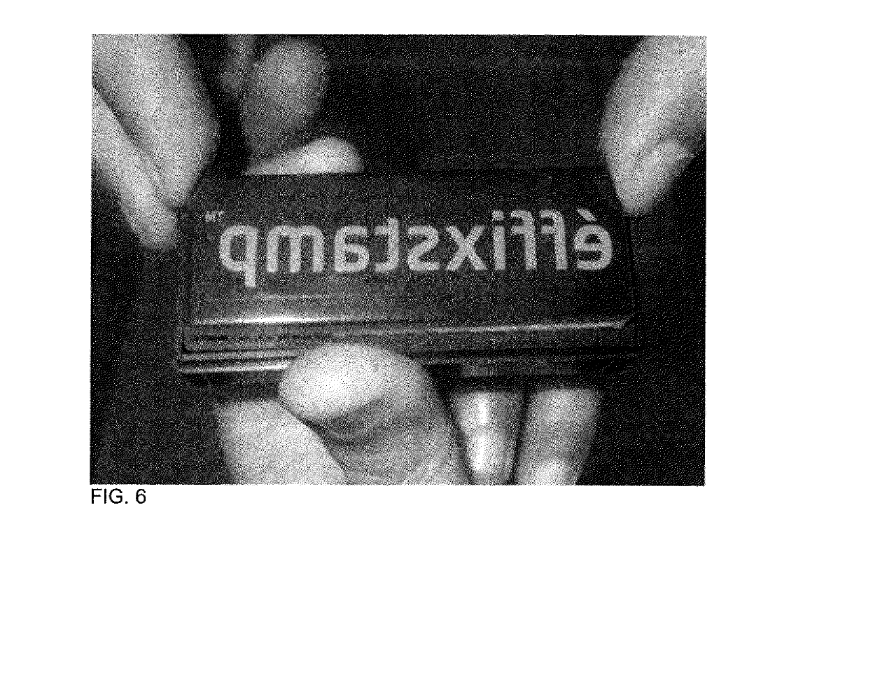

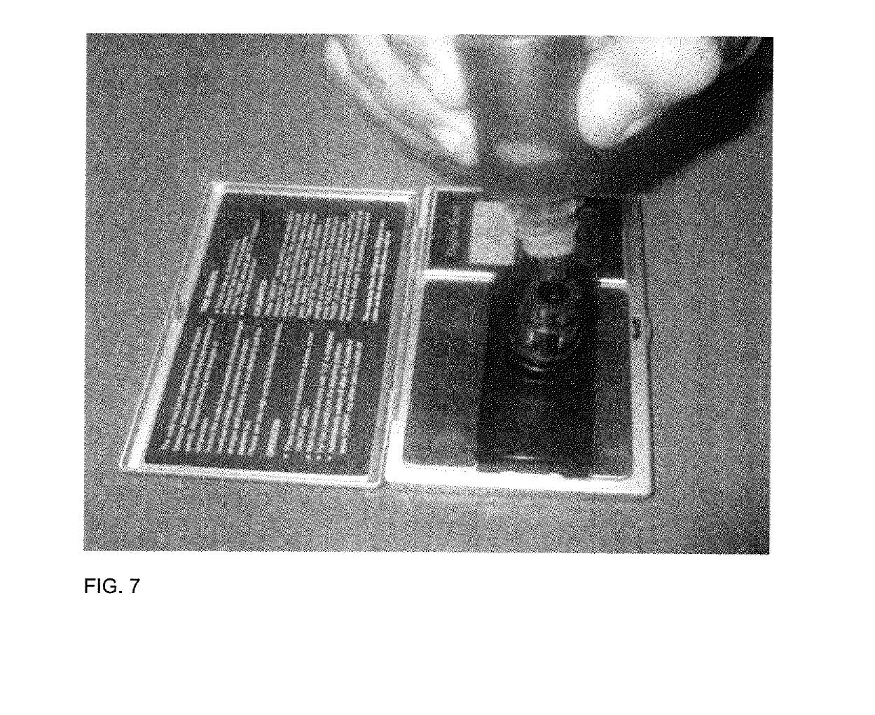

FIG. 2 shows an automated fluid dispensing equipment. The process of gluing is done with this equipment, and ensuring right proportions of glue distribution and right adhesion quality. On application of the glue both the items are pressed using pressing equipment. The bonded microporous synthetic rubber is developed in various sizes with a minimum sheet size of 10 mm×10 mm and a maximum sheet size of 330×160 mm and the thickness of the microporous synthetic rubber ranges from 4 mm to 7 mm.

FIG. 3 shows a flash stamp exposure system. The process further includes the step of placing a tracing sheet in which the desired text of the stamp sought is created on the microporous synthetic rubber. The tracing sheet placed on the microporous synthetic rubber is exposed in a flash sealing machine with xenon tubes (FIG. 3). The xenon tubes glow with a flash thereby sealing the non-printing area of the microporous synthetic rubber and producing an image of the desired text for a stamp with precise resolution. The glue is applied to the refillable stamp mount accordingly as shown in FIG. 4 and on the sides of the microporous synthetic rubber as shown in FIG. 5.

FIG. 6 illustrates the image of sealed microporous synthetic rubber after gets glued to the refillable stamp mount. The refillable stamp mount further includes an inking tube through which the flash ink can be poured according to FIG. 7.

The present invention also discusses the quantity of Flash Preink Ink to be poured. It depends on the text area of the flash preink stamp. The approximate quantity ranges between 3 ml/stamp and 12 ml/stamp. The absorption time of ink to the synthetic rubber through the polypropylene foam depends on the size of the Flash Preink Stamp. The minimum time for absorption is 15 minutes and maximum of 1½ hour/stamp. Once the Ink gets transferred to the synthetic rubber the Flash Preink Stamp is ready for use.

The bonded microporous synthetic rubber of the present invention exhibits numerous practical advantages when compared to other conventional microporous stamp pad materials for use with self-inked stamps. The advantages, but not limited to the following, are a) Better ink retention is achieved due to higher thickness (8 mm) of the product and thus helps in delivering more number of impressions per inking. b) The ink absorption is very fast as the polypropylene material has a fast absorption property and it further transfers the ink to the synthetic rubber, which can retain the ink and deliver an impression while pressed. c) Fixed quantity of ink is poured through the inking tube and this helps in reducing the wastage of ink and also eradicates the whole process of dipping the product for ink absorption. d) As the measured quantity of inks is poured, there are no chances of over inking in the stamp. e) Use of bonded microporous synthetic rubber delivers non spreading impressions.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A bonded microporous synthetic rubber, used in the manufacturing of pre-inked stamps comprising:
(a) a synthetic rubber; and
(b) a polypropylene foam.

2. The synthetic rubber of claim 1, has a porous structure which can retain ink in itself and gradually deliver small amount of ink when pressed.

3. The polypropylene foam of claim 1, is a stamp pad material which absorbs ink quickly and has a property of further transferring the ink.

4. The bonded microporous synthetic rubber of claim 1, is made by gluing the synthetic rubber and the polypropylene foam with the synthetic glue.

5. The process of gluing according to claim 4, is done by an automated fluid dispensing equipment.

6. The glued microporous synthetic rubber according to claim 4, wherein said bonded microporous synthetic rubber further placed in a tracing sheet containing the image of the desired text of the stamp and it is exposed in a flash stamp system.

7. The flash stamp system according to claim 6, includes xenon tubes which delivers intense burst of light that seals the microporous synthetic rubber and creates the text desired image for a stamp.

8. The system according to claim 7, wherein the image is created on the bonded microporous synthetic rubber and the said synthetic rubber is glued to a refillable stamp mount/pocket stamp mount.

9. The refillable stamp mount according to claim 8, further includes an inking tube through which the flash ink can be poured.

10. Bonded microporous synthetic rubber according to claim 1, used in the manufacture of flash preink stamps.
